(19) United States
(12) Patent Application Publication
(10) Pub. No.: US 2024/0424649 A1
(43) Pub. Date: Dec. 26, 2024

(54) Hand Tool Structure

(71) Applicant: Chang-Yu Tsai, Taichung City (TW)

(72) Inventors: Chang-Yu Tsai, Taichung City (TW); Chiung-Chang Tsai, Taichung City (TW)

(21) Appl. No.: 18/337,638

(22) Filed: Jun. 20, 2023

(51) Int. Cl. B25B 23/16; B25B 13/48; B25G 1/10

(52) U.S. Cl. CPC B25B 23/16; B25B 13/48; B25G 1/105

(57) ABSTRACT

A hand tool structure includes a main body and a laser body mounted on the main body. The main body is provided with at least one operation end. The laser body is formed on a whole surface or a partial surface of the at least one operation end by a working machine during a laser process. The whole surface or partial surface of the at least one operation end is provided with at least one first friction face formed by the laser process. The at least one first friction face is a rough surface with particles. The at least one first friction face increases a contact friction force between the at least one operation end and the workpiece.

### BACKGROUND OF THE INVENTION

### Field of the Invention

The present invention relates to a hand tool and, more particularly, to a hand tool structure.

### Description of the Related Art

A conventional hand tool was disclosed in the U.S. Pat. No. 8,020,473, and comprises a main body 10, at least one second body 20, and a cover 40. The main body 10 is a handle and is provided with at least one slot 11 and an opening 111. The at least one second body 20 is mounted in the at least one slot 11 and is provided with a grinding face 21. The cover 40 seals the at least one second body 20 in the at least one slot 11. When the main body 10 contacts an oily liquid, such as engine oil, lubricating oil, etc., in the workplace, the main body 10 easily slips from the workpiece, thereby causing inconvenience to the operator. The grinding face 21 provides an anti-slip function to increase the friction between the main body 10 and the workpiece so that the main body 10 will not slip from the workpiece during operation. However, the grinding face 21 only provides an anti-slip function and cannot increase the function of the main body 10, thereby limiting the versatility of the hand tool.

### BRIEF SUMMARY OF THE INVENTION

In accordance with the present invention, there is provided a hand tool structure comprising a main body, and a laser body mounted on the main body. The main body is an open end wrench, a box end wrench, a combination open and box end wrench, a pipe wrench, a ratchet wrench, a composite wrench, a socket wrench, a socket, an adjustable wrench, a ratchet wheel, a universal socket. The main body is a hand tool structure. The main body is provided with at least one operation end. The laser body is formed on a whole surface or a partial surface of the at least one operation end by a working machine during a laser process. The whole surface or partial surface of the at least one operation end is provided with at least one first friction face formed by the laser process. The at least one first friction face is a rough surface with particles. The at least one first friction face increases a contact friction force between the at least one operation end and the workpiece to prevent the workpiece from slipping from the at least one operation end.

According to the primary advantages of the present invention, the friction face increases the friction force between the operation end and the workpiece when contacting, to prevent the workpiece from slipping from the operation end. The surface of the operation end is provided with the laser body. When the workpiece produces burrs, the laser body on the main body is used as a grinding tool to remove the burrs on the workpiece without having to use or purchase a sander, thereby saving the working time.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hand tool structure in accordance with the first preferred embodiment of the present invention.

FIG. 2 is a top view of the hand tool structure as shown in FIG. 1.

FIG. 3 is a cross-sectional view of the hand tool structure taken along line A-A as shown in FIG. 2.

FIG. 4 is a locally enlarged view of the hand tool structure taken along circle B as shown in FIG. 2.

FIG. 5 is a cross-sectional view of the hand tool structure taken along line C-C as shown in FIG. 2.

FIG. 6 is a perspective view of a hand tool structure in accordance with the second preferred embodiment of the present invention.

FIG. 7 is a perspective view of a hand tool structure in accordance with the third preferred embodiment of the present invention.

FIG. 8 is a perspective view of a hand tool structure in accordance with the fourth preferred embodiment of the present invention.

FIG. 9 is a perspective view of a hand tool structure in accordance with the fifth preferred embodiment of the present invention.

FIG. 10 is a perspective view of a hand tool structure in accordance with the sixth preferred embodiment of the present invention.

FIG. 11 is a perspective view of a hand tool structure in accordance with the seventh preferred embodiment of the present invention.

### DETAILED DESCRIPTION OF THE INVENTION

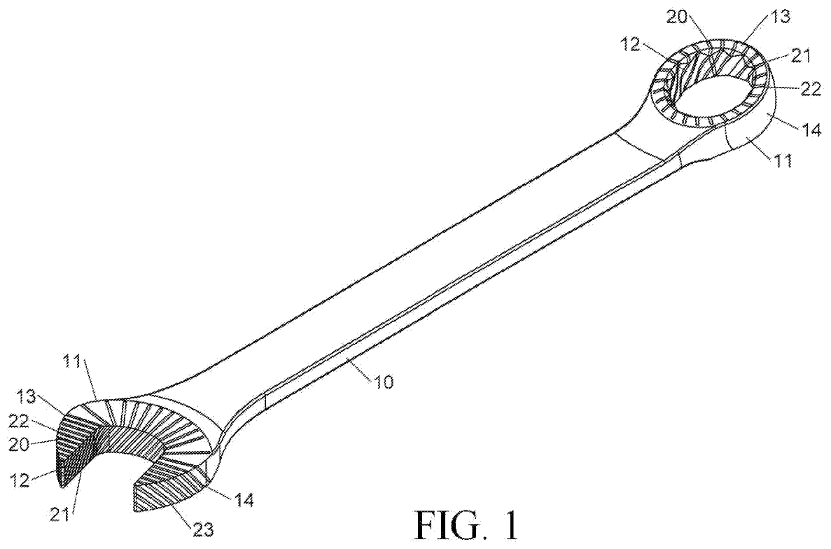

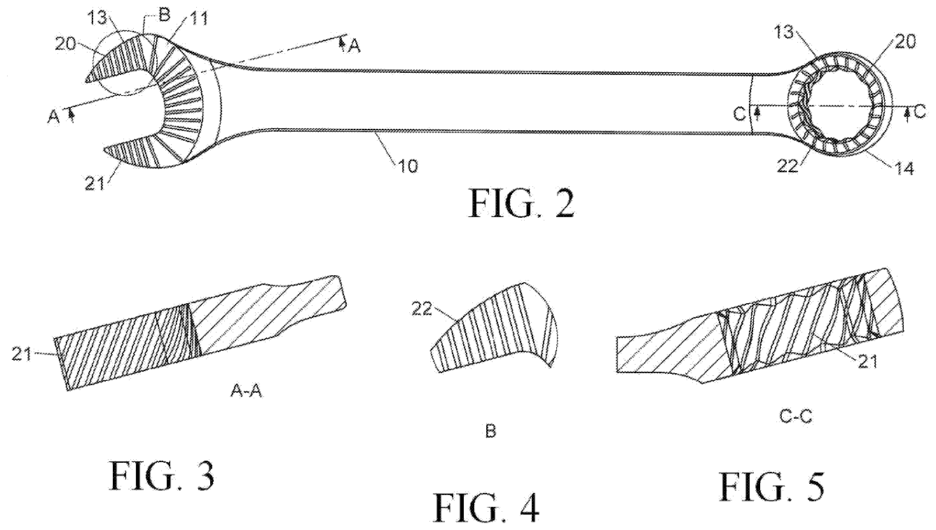

Referring to the drawings and initially to FIGS. 1-5, a hand tool structure in accordance with the preferred embodiment of the present invention comprises a main body 10 and a laser body 20 mounted on the main body 10.

The main body 10 is an open end wrench, a box end wrench, a combination open and box end wrench, a pipe wrench, a ratchet wrench, a composite wrench, a socket wrench, a socket, an adjustable wrench, a ratchet wheel, a universal socket. The main body 10 is preferably a hand tool structure.

The main body 10 is provided with at least one operation end (or an active end or a working end) 11. The at least one operation end 11 is a surface contacting another element. The operation end 11 is a surface contacting a workpiece. The operation end 11 is a surface for rotating a workpiece.

The main body 10 is provided with two operation ends 11 formed on two ends of the main body 10. One of the two operation ends 11 is an open end having two faces parallel with each other. One of the two operation ends 11 has a planar shape or an arcuate convex shape. The other of the two operation ends 11 is an open end having a polygonal mounting recess. Thus, the main body 10 is a combination open and box end wrench structure.

The at least one operation end 11 includes a first surface 12, a second surface 13, and a third surface 14. The first surface 12 is formed on an inner face of the at least one operation end 11 and contacts the workpiece. The second surface 13 is formed on an end face of the at least one operation end 11. The third surface 14 is formed on a peripheral face of the at least one operation end 11.

The laser body 20 is mounted on the at least one operation end 11. The laser body 20 is formed on a whole surface or a partial surface of the at least one operation end 11 by a working machine during a laser process. A laser light is applied on the at least one operation end 11. The whole surface or partial surface of the at least one operation end 11 is provided with at least one first friction face 21 formed by the laser process, including peeling, coloring, concentration, or carbonization. The at least one first friction face 21 is a rough surface with particles. The at least one first friction face 21 increases a contact friction force between the at least one operation end 11 and the workpiece to prevent the workpiece from slipping from the at least one operation end 11.

The laser body 20 is provided with at least one second friction face 22 and at least one third friction face 23. The at least one first friction face 21 is provided on the first surface 12 of the at least one operation end 11. The at least one second friction face 22 is provided on the second surface 13 of the at least one operation end 11. The at least one third friction face 23 is provided on the third surface 14 of the at least one operation end 11.

The laser process includes diverse methods and will not be described in detail. The at least one operation end 11 is provided with the laser body 20. The at least one first friction face 21, the at least one second friction face 22, and the at least one third friction face 23 of the laser body 20 are formed by the laser process.

The laser body 20 is provided on a surface of the at least one operation end 11. The surface of the at least one operation end 11 is provided with the at least one first friction face 21, the at least one second friction face 22, and the at least one third friction face 23. The at least one first friction face 21, the at least one second friction face 22, and the at least one third friction face 23 cover at least one third (⅓) of the surface of the at least one operation end 11.

When the at least one first friction face 21, the at least one second friction face 22, and the at least one third friction face 23 are provided on the partial surface of the at least one operation end 11, the laser body 20 includes multiple first friction faces 21, multiple second friction faces 22, and multiple third friction faces 23. Thus, the first friction faces 21, the second friction faces 22, and the third friction faces 23 are distributed on the partial surface of the at least one operation end 11.

When the at least one first friction face 21, the at least one second friction face 22, and the at least one third friction face 23 are provided on the whole surface of the at least one operation end 11, the laser body 20 includes multiple first friction faces 21, multiple second friction faces 22, and multiple third friction faces 23. As shown in FIGS. 3 and 5, the first friction faces 21 are arranged obliquely relative to the at least one operation end 11. An angle of forty-five degrees (45°) is defined between each of the first friction faces 21 and a side of the at least one operation end 11. As shown in FIG. 4, multiple angles are defined between each of the second friction faces 22 and the at least one operation end 11. An angle of forty-five degrees (45°) is also defined between each of the third friction faces 23 and a side of the at least one operation end 11 as shown in FIG. 1.

Similarly, the first friction faces 21, the second friction faces 22, and the third friction faces 23 are arranged linearly relative to the at least one operation end 11. Thus, the first friction faces 21, the second friction faces 22, the third friction faces 23, and the at least one operation end 11 are parallel with each other. Alternatively, the first friction faces 21, the second friction faces 22, and the third friction faces 23 are arranged transversely relative to the at least one operation end 11.

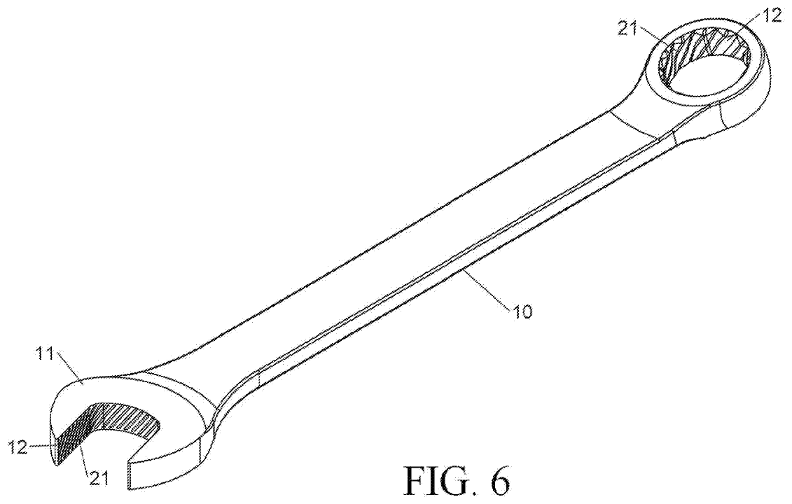

Referring to FIG. 6, the at least one operation end 11 is provided with the first friction faces 21 only, without having the second friction faces 22 and the third friction faces 23.

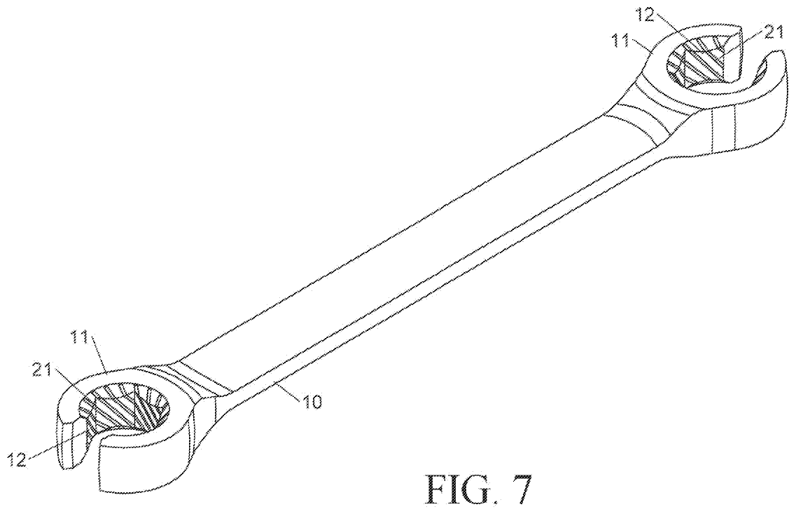

Referring to FIG. 7, the main body 10 is a pipe wrench. In addition, the at least one operation end 11 is provided with the first friction faces 21 only, without having the second friction faces 22 and the third friction faces 23.

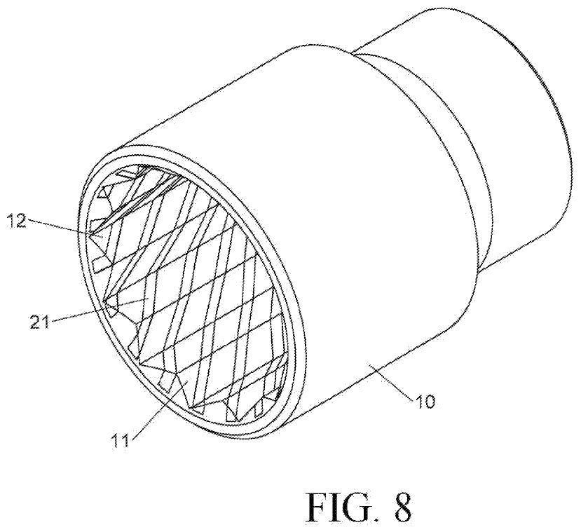

Referring to FIG. 8, the main body 10 is a socket structure, and the at least one operation end 11 is a polygonal mounting recess for mounting a screw member. In addition, the at least one operation end 11 is provided with the first friction faces 21 only.

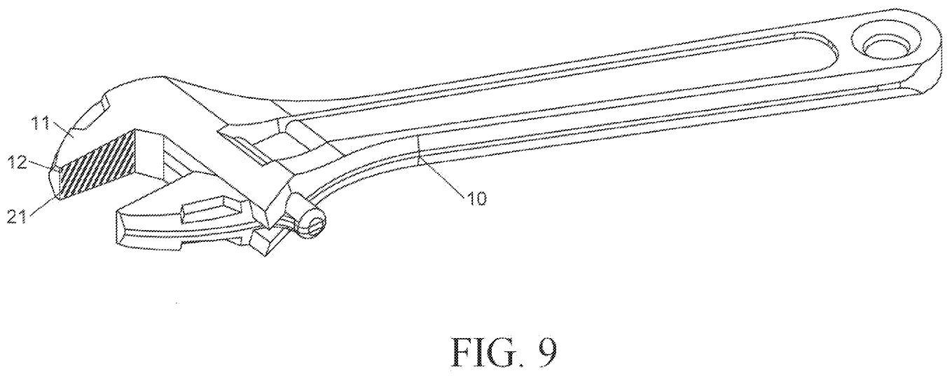

Referring to FIG. 9, the main body 10 is an adjustable wrench structure.

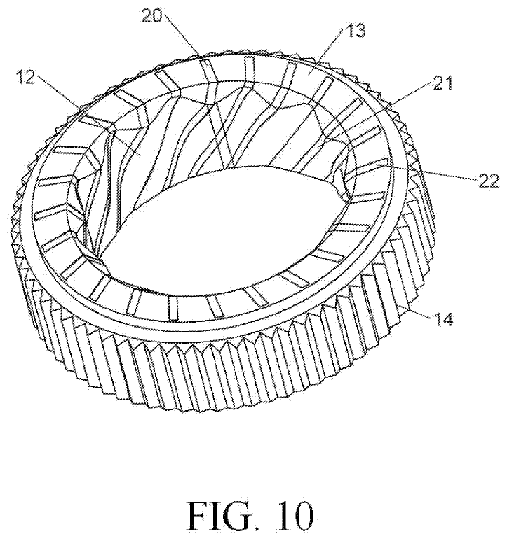

Referring to FIG. 10, the main body 10 is a ratchet wheel structure.

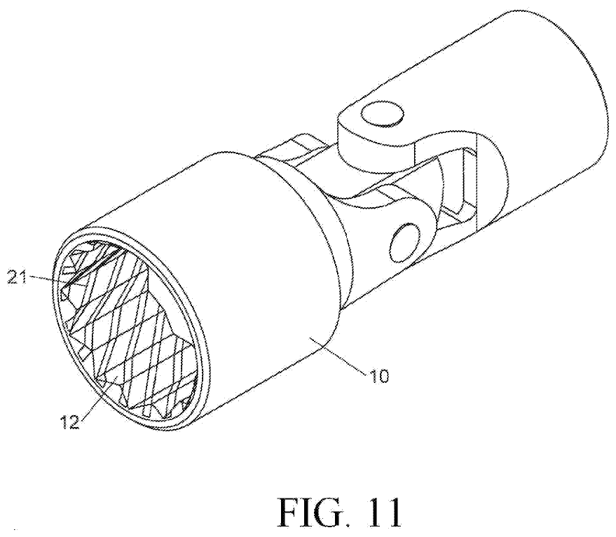

Referring to FIG. 11, the main body 10 is a universal socket structure.

Again referring to FIG. 1, the main body 10 is a combination open and box end wrench structure. In accordance with another preferred embodiment of the present invention, the main body 10 is a double open end wrench structure, and each of the two operation ends 11 of the main body 10 is an open end. Alternatively, the main body 10 is a double box end wrench structure, and each of the two operation ends 11 of the main body 10 is a box end.

Accordingly, the hand tool structure of the present invention has the following advantages.
1. Referring to FIG. 1, the at least one first friction face 21 increases the friction force between the at least one operation end 11 and the workpiece when contacting, to prevent the workpiece from slipping from the at least one operation end 11.
2. The surface of the at least one operation end 11 is provided with the laser body 20 with the at least one first friction face 21. When the workpiece produces burrs, the laser body 20 on the main body 10 is used as a grinding tool to remove the burrs on the workpiece without having to use or purchase a sander, thereby saving the working time.
3. When the at least one operation end 11 contacts an oily liquid, such as engine oil, lubricating oil, etc., on the workplace, the at least one operation end 11 easily slips from the workpiece, thereby causing inconvenience to the operator. The at least one first friction face 21 is made by the laser process and provides an anti-slip function to increase the friction resistance during operation of the at least one operation end 11.
4. The at least one first friction face 21 of the laser body 20 is provided with colors, characters, or figures to increase identification of the at least one operation end 11.
5. The at least one operation end 11 is provided with the at least one first friction face 21 so that the hand tool structure has the maximum friction force.
6. The at least one first friction face 21 is provided on the main body 10 through a predetermined path set by a program. The laser body 20 is made by a conventional method. Thus, the main body 10 is provided with the laser body 20 to decrease the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A hand tool structure comprising:
a main body; and
a laser body mounted on the main body;
wherein:
the main body is an open end wrench, a box end wrench, a combination open and box end wrench, a pipe wrench, a ratchet wrench, a composite wrench, a socket wrench, a socket, an adjustable wrench, a ratchet wheel, a universal socket;
the main body is a hand tool structure;
the main body is provided with at least one operation end;
the at least one operation end is a surface contacting another element;
the operation end is a surface contacting a workpiece;
the operation end is a surface for rotating a workpiece;
the at least one operation end includes a first surface, a second surface, and a third surface;
the first surface is formed on an inner face of the at least one operation end and contacts the workpiece;
the second surface is formed on an end face of the at least one operation end;
the third surface is formed on a peripheral face of the at least one operation end;
the laser body is mounted on the at least one operation end;
the laser body is formed on a whole surface or a partial surface of the at least one operation end by a working machine during a laser process;
the whole surface or partial surface of the at least one operation end is provided with at least one first friction face formed by the laser process, including peeling, coloring, concentration, or carbonization;
the at least one first friction face is a rough surface with particles;
the at least one first friction face increases a contact friction force between the at least one operation end and the workpiece to prevent the workpiece from slipping from the at least one operation end;
the laser body is provided on a surface of the at least one operation end;
the surface of the at least one operation end is provided with the at least one first friction face;
the at least one first friction face covers at least one third of the surface of the at least one operation end;
when the at least one first friction face is provided on the partial surface of the at least one operation end, the laser body includes multiple first friction faces;
the first friction faces are distributed on the partial surface of the at least one operation end;
when the at least one first friction face are provided on the whole surface of the at least one operation end, the laser body includes multiple first friction faces;
the first friction faces are arranged obliquely relative to the at least one operation end;
an angle of forty-five degrees is defined between each of the first friction faces and a side of the at least one operation end;
the first friction faces are arranged linearly relative to the at least one operation end;
the first friction faces and the at least one operation end are parallel with each other; and
the first friction faces are arranged transversely relative to the at least one operation end.

2. The hand tool structure as claimed in claim 1, wherein:
the main body is provided with two operation ends formed on two ends of the main body;
one of the two operation ends is an open end having two faces parallel with each other;
one of the two operation ends has a planar shape or an arcuate convex shape;
the other of the two operation ends is an open end having a polygonal mounting recess; and
the main body is a combination open and box end wrench structure.

3. The hand tool structure as claimed in claim 1, wherein:
the laser body is provided with at least one second friction face and at least one third friction face;
the at least one first friction face is provided on the first surface of the at least one operation end;
the at least one second friction face is provided on the second surface of the at least one operation end; and
the at least one third friction face is provided on the third surface of the at least one operation end.

4. The hand tool structure as claimed in claim 3, wherein:
the laser process includes diverse methods;
the at least one operation end is provided with the laser body; and
the at least one first friction face, the at least one second friction face, and the at least one third friction face of the laser body are formed by the laser process.

5. The hand tool structure as claimed in claim 3, wherein:
the laser body is provided on a surface of the at least one operation end;
the surface of the at least one operation end is provided with the at least one first friction face, the at least one second friction face, and the at least one third friction face; and
the at least one first friction face, the at least one second friction face, and the at least one third friction face cover at least one third of the surface of the at least one operation end.

6. The hand tool structure as claimed in claim 3, wherein:
when the at least one first friction face, the at least one second friction face, and the at least one third friction face are provided on the partial surface of the at least one operation end, the laser body includes multiple first friction faces, multiple second friction faces, and multiple third friction faces; and
the first friction faces, the second friction faces, and the third friction faces are distributed on the partial surface of the at least one operation end 11.

7. The hand tool structure as claimed in claim 3, wherein:
when the at least one first friction face, the at least one second friction face, and the at least one third friction face are provided on the whole surface of the at least one operation end, the laser body includes multiple first friction faces, multiple second friction faces, and multiple third friction faces;
the first friction faces are arranged obliquely relative to the at least one operation end;
an angle of forty-five degrees is defined between each of the first friction faces and a side of the at least one operation end;
multiple angles are defined between each of the second friction faces and the at least one operation end; and
an angle of forty-five degrees is defined between each of the third friction faces and a side of the at least one operation end.

8. The hand tool structure as claimed in claim 3, wherein:
the first friction faces, the second friction faces, and the third friction faces are arranged linearly relative to the at least one operation end;
the first friction faces, the second friction faces, the third friction faces, and the at least one operation end are parallel with each other; or
the first friction faces, the second friction faces, and the third friction faces are arranged transversely relative to the at least one operation end.

9. The hand tool structure as claimed in claim 1, wherein the main body is a socket structure, and the at least one operation end is a polygonal mounting recess.

10. The hand tool structure as claimed in claim 1, wherein:
the main body is a double open end wrench structure;
each of the two operation ends of the main body is an open end; or
the main body is a double box end wrench structure, and each of the two operation ends of the main body is a box end.
